(19) United States
(12) Patent Application Publication
(10) Pub. No.: US 2005/0180137 A1
(43) Pub. Date: Aug. 18, 2005

(54) LED light bulb

(76) Inventor: Tsai-Cheng Hsu, Taipei Hsien (TW)

Correspondence Address: SUPREME PATENT SERVICES, POST OFFICE BOX 2339, SARATOGA, CA, 95070, US

(21) Appl. No.: 10/779,347

(22) Filed: Feb. 14, 2004

(51) Int. Cl. F21V 21/00

(52) U.S. Cl. 362/249

(57) ABSTRACT

An LED bulb is provided, including a light bulb head, a case, an electronic control board, an LED unit and a light bulb cover. The light bulb head, the case and the bulb cover are engaged together to form an enclosing space to house the electronic control board and the LED unit. The parts are electrically connected by conductive a conductive wire. The electronic control board can convert an AC input into a DC current to supply power to the LED unit. The electronic control board also provides functions including illumination, timed illumination, luminance control and color changes. A power switch is used together with the electronic control board to control the power input and function setting and switching.

### FIELD OF THE INVENTION

The present invention relates to a light bulb structure and, more particularly, to a light emitting diode (LED) light bulb.

### BACKGROUND OF THE INVENTION

Conventional light bulbs are only for illumination and are relying on switches for controlling. To have additional functions such as timed illumination or luminance adjustment, additional circuit or controller must be routed or installed. It is not only inconvenient and costly, but also affecting the overall looks of the original lighting installation.

As the lighting requirement is increasingly sophisticated, the conventional light bulbs can no longer satisfy the various and multi-functional lighting needs for atmosphere enhancement. In addition, as the consciousness of environmental protection grows, the demand of energy-saving electrical devices also increases.

### SUMMARY OF THE INVENTION

The primary object of the present invention is to provide a multi-functional light bulb. In addition to illumination, the present invention provides functions including timed illumination, luminance control and color changes. The present invention includes a light bulb head, a case, an electronic control board, an LED unit and a light bulb cover. The light bulb head, the case and the bulb cover are engaged together to form an enclosing space to house the electronic control board and the LED unit. The parts are electrically connected by conductive a conductive wire. The light bulb head of the present invention has the shape of a conventional light bulb and therefore, the present invention can be used to replace the conventional light bulb used in the current lighting apparatus.

The advantages of the present invention include:

(1) The present invention has the same light bulb head as a conventional light bulb and is able to replace the conventional light bulb used in current lighting apparatus.

(2) The present invention is easy to change and install as the conventional light bulb.

(3) The LED used in the present invention can have different shapes and colors to provide varieties in the design. The LED also has the advantages of lightweight, low energy consumption, long life span and high luminance. When the LED is used with the electronic control board of the present invention, the light bulb can display various colors or various lighting modes such as blinking.

No additional controllers are required to set the multi-function displaying mode. The conventional light switches installed in the households can be used to control the display mode.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

FIG. 1 shows an exploded view of the present invention.

FIG. 2 shows a circuit block diagram of the present invention.

FIG. 3 shows a detailed circuit diagram of the present invention.

FIG. 4 shows a light bulb cover of spherical shape in accordance with the present invention.

FIG. 5 shows a light bulb cover of screw shape in accordance with the present invention.

FIG. 6 shows a light bulb cover of 3U shape in accordance with the present invention.

FIG. 7 shows a routing diagram used in the present invention.

### DETAILED DESCRIPTION OF THE PREFERRED EMBODIMENT

The present invention can be further described in details with the accompanying figures.

The present invention provides an LED light bulb, including: a light bulb head 1, a case 2, an electronic control board 3, an LED unit 4, and a light bulb cover 5. Light bulb head 1, case 2, and light bulb cover 5 are engaged together to form an enclosing space to house electronic control board 3 and LED unit 4, which are electrically connected by conductive wires.

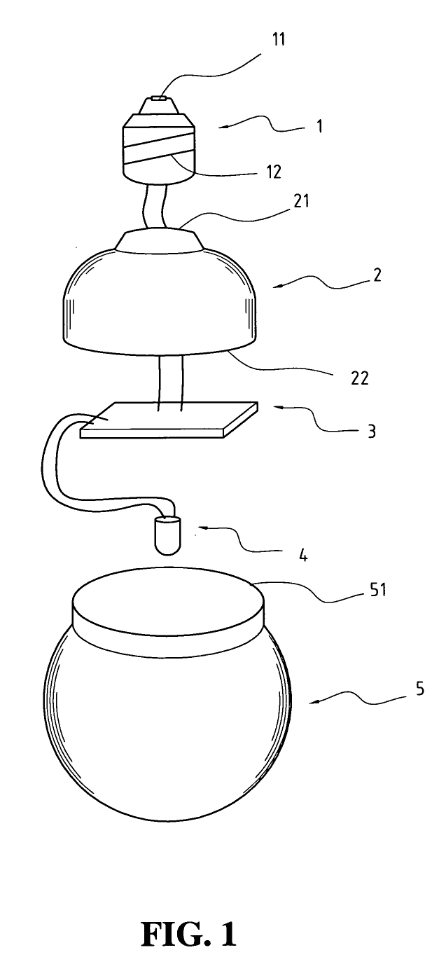

FIG. 1 shows an exploded view of the present invention. As shown in FIG. 1, light bulb head 1 includes a bump point 11 and a screw cap 12. An insulation material is used to separate bump point 11 and screw cap 12 so that bump point 11 and screw cap 12 become two electrical contact points. This is the same as the conventional light bulb head. Therefore, the present invention can be used in the conventional lighting apparatus.

Case 2 is a bell-shaped hollow shell with a top hole 21 and a bottom hole 22. The size of the top hole 21 matches the size of the outer rim of light bulb head 1. Top hole 21 is tightly fitted, soldered, or sealed with glue to the outer rim. Similarly, bottom hole 22 is connected to light bulb cover 5.

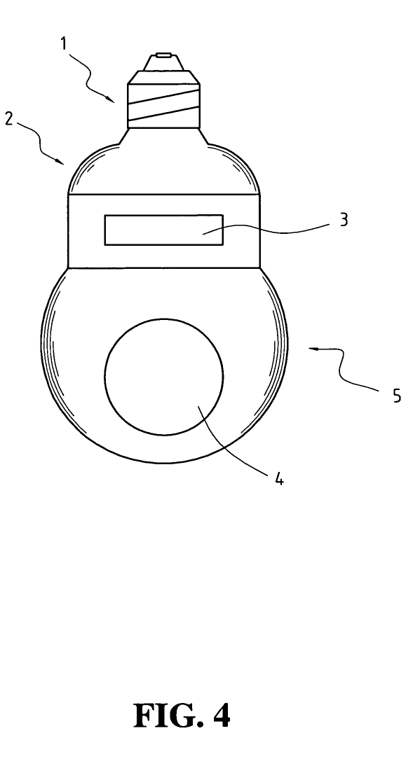

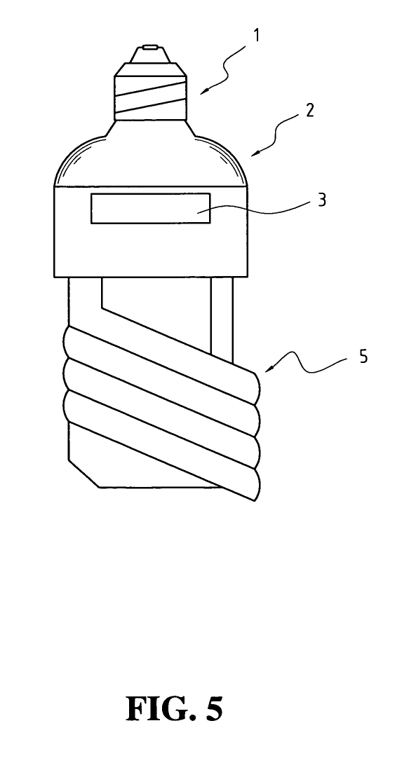

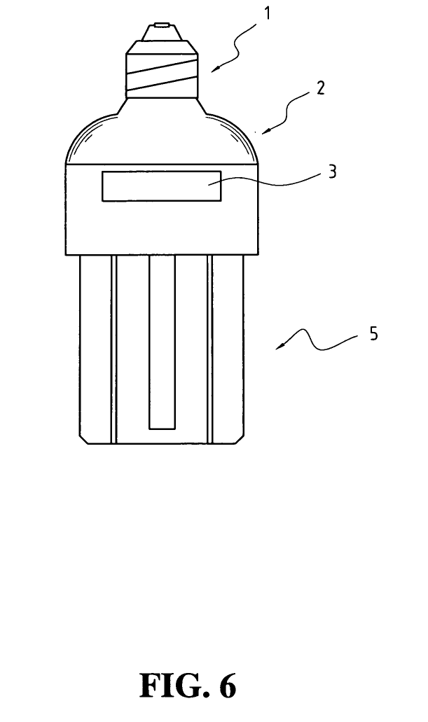

Light bulb cover 5 is to protect LED unit 4 and its internal circuit. It is also used to uniformize the light from LED unit 4. Therefore, light bulb cover 5 is a hollow cover that provides an enclosed space to house electronic control board 3 and LED unit 4. Light bulb cover 5 has an open hole 51, which has the size to match the inner rim of bottom hole 22 of case 2. Light bulb cover 5 may have the shape of a sphere, a screw, or 3U, as shown in FIGS. 4, 5, and 6. Case 2 and light bulb cover 5 can be screwed together or using other engaging methods.

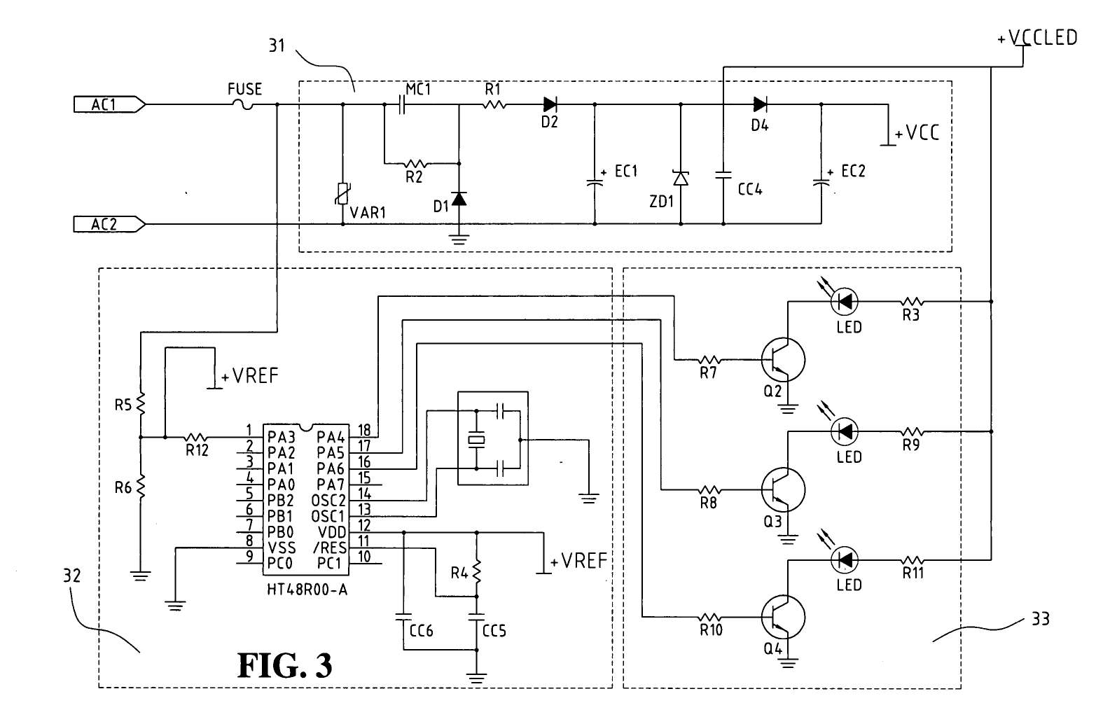

FIG. 3 shows a circuit diagram of electronic control board 3. Electronic control board 3 includes a power supply circuit 31, a control circuit 32 and an LED circuit 33. Power supply circuit 31 is for connecting to light bulb head 1 and converting the AC to DC to supply power to control circuit 32, LED circuit 33 and LED unit 4. Control circuit 32 includes a control IC, an oscillator, and other electronic elements. Control circuit 32 can detect the changes of signals from the switch in order to control the timing, color change, luminance and other lighting mode, such as blinking. LED circuit 33 is connected to drive LED unit 4. LED unit 4 can include one or more LEDs for better luminance. The present invention can also use different color LEDs to improve the variety of lighting mode.

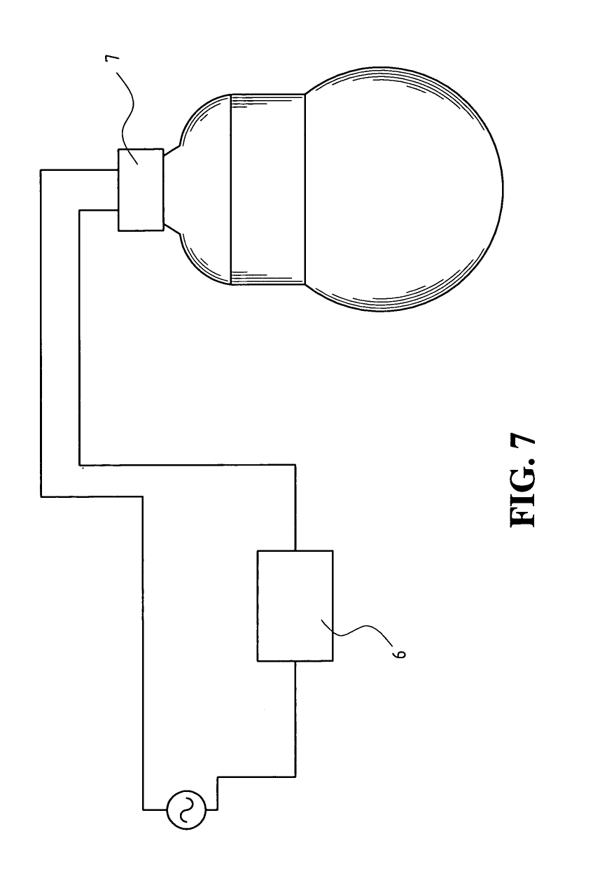

Referring to FIGS. 1 and 7, the AC power source is connected to a switch 6 at one end, and to a light bulb base 7 at the other. Switch 6 is also connected to light bulb base 7 to form a circuit loop. Light bulb head 1 of the present invention is screwed into light bulb base 7. Conductive wires are used to connect light bulb head 1 to electronic control board 3, and electronic control board 3 to LED unit 4. Electronic control board 3 uses the signal from switch 6 to control the display mode of the LED.

Switch 6 uses successive on-and-off flips to provide the signals to electronic control board 3 for controlling functions. For simple illumination, use switch 6 as a conventional light switch. Switch the light bulb on or off with a single flip. To switch to additional display modes, such as timed illumination, luminance control, or color change functions, provided by the present invention, a series of successive flips must be performed on switch 6 in order to send the signal to electronic control board 3.

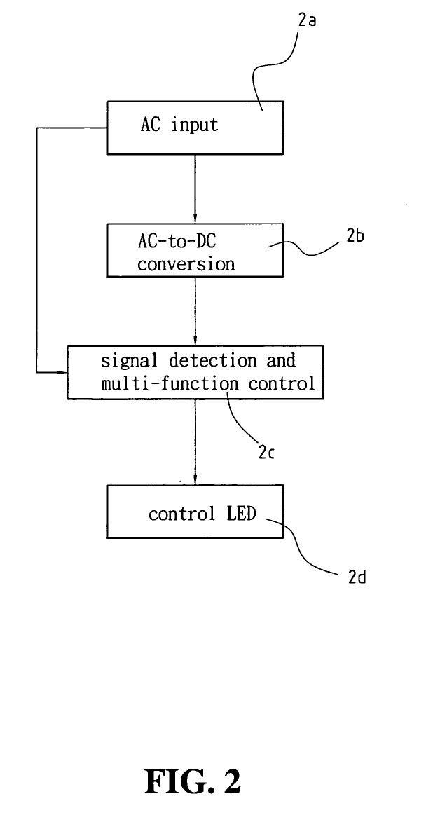

Referring to FIGS. 2 and 3, when the AC input 2a is supplied to power supply circuit 31, power supply circuit 31 converts the AC input into a DC power 2b to provide power to control circuit 32, LED circuit 33, and LED unit 4. AC input 2a also provides power to signal detection and multi-function control 2c. Signal detection and multi-function control 2c is made of control circuit 32 and switch 6. When a series of successive flips are performed on switch 6, control circuit 32 will take the series of flips as signal to switch to a different function provided by the present invention, such as timed illumination, different color lighting, blinking or luminance control. Switch 6 can also be used when a DC power supply is used as the power supply to the present invention.

In accordance with the aforementioned description, the LED light bulb of the present invention has the following features:

(1) Timed illumination: the electronic control board of the present invention has the timer function to control the LED, so that the switch can be flipped successively to set the electronic control board to a pre-set time such as 1, 2 or 8 hours.

(2) Luminance control: the electronic control board of the present invention has the luminance control function to control the LED by either controlling the electrical current when a single LED is used or the number of LEDs on when a plurality of LEDs are used. Similarly, the switch can be flipped successively to set the electronic control board to turning on a pre-set number of LEDs or to a preset electrical current.

(3) Light color change: the electronic control board of the present invention has the light color change function to control the LED when a plurality of different color LEDs are used. The LEDs of the same color can be grouped. Different groups of LEDs can be on in a sequence to create a blinking effect, or mixed to show different colors. Similarly, the switch can be flipped successively to set the electronic control board to turn on a group of LEDs in sequence or simultaneously.

While the invention has been described in connection with what is presently considered to the most practical and preferred embodiment, it is to be understood that the invention is not to be limited to the disclosed embodiment, but, on the contrary, it should be clear to those skilled in the art that the description of the embodiment is intended to cover various modifications and equivalent arrangement included within the spirit and scope of the appended claims.

1. An LED light bulb, comprising a light bulb head, a case, an LED unit, an electronic control board, and a light bulb cover; where the light bulb head is connected to the case, and the case is connected to the light bulb cover to form an enclosed space to house the electronic control board and the LED unit, conductive wires being used to electrically connect the light bulb head, the electronic control board and the LED unit, the electronic control board further comprising a power supply circuit, a control circuit, and an LED circuit, where the power supply circuit is used to convert an AC input to a DC current to provide power to the control circuit and the LED circuit, the control circuit being used to control the LED circuit to drive the LED unit, the control circuit using signals from a switch to determine the requested function and control the LED unit accordingly.

2. The LED light bulb as claimed in claim 1, wherein the switch is connected to a power supply at one end and to the LED light bulb at the other for controlling the power input, and function setting and switching.

3. The LED light bulb as claimed in claim 1, wherein the switch is for controlling power input.

4. The LED light bulb as claimed in claim 1, wherein the switch is for function setting and switching.

5. The LED light bulb as claimed in claim 1, wherein the light bulb head is compatible with a light bulb base of conventional light bulbs.

6. The LED light bulb as claimed in claim 1, wherein the LED unit comprises a single LED.

7. The LED light bulb as claimed in claim 1, wherein the LED unit comprises a plurality of LEDs.

8. The LED light bulb as claimed in claim 1, wherein the control circuit is a timer circuit.

9. The LED light bulb as claimed in claim 1, wherein the control circuit is a luminance control circuit.

10. The LED light bulb as claimed in claim 1, wherein the control circuit is a color control circuit.

11. The LED light bulb as claimed in claim 1, wherein the control circuit comprises a timer circuit, a luminance control circuit, and a color control circuit.

12. The LED light bulb as claimed in claim 1, wherein the light bulb cover is spherical.

13. The LED light bulb as claimed in claim 1, wherein the light bulb cover is screw-shaped.

14. The LED light bulb as claimed in claim 1, wherein the light bulb cover is 3U-shaped.

15. The LED light bulb as claimed in claim 1, wherein the light bulb head and the case are sealed with glue.
